(19) United States
(12) Patent Application Publication
(10) Pub. No.: US 2017/0072903 A1
(43) Pub. Date: Mar. 16, 2017

(54) VEHICLE OCCUPANT AND SEATBELT USAGE INDICATING SYSTEM

(71) Applicants: Saed Farshchi, Clearwater, FL (US); Steve Farshi, Clearwater, FL (US)

(72) Inventors: Saed Farshchi, Clearwater, FL (US); Steve Farshi, Clearwater, FL (US)

(21) Appl. No.: 14/851,259

(22) Filed: Sep. 11, 2015

(51) Int. Cl. B60R 22/48

(52) U.S. Cl. CPC B60R 22/48; B60R 2022/4816; B60R 2022/4858; B60R 2022/4866; B60R 2022/4875

(57) ABSTRACT

A vehicle occupant and seatbelt usage indicating system includes a vehicle with a plurality of seats each including a seatbelt assembly with an engagement sensor to detect usage. Each of the seats has one of a plurality of occupant sensors therein. A processor is mounted in the vehicle. Each of the occupant sensors and each of the engagement sensors are electrically coupled to the processor. The engagement sensors are each associated with one of the occupant sensors to define a paired sensor indicating occupancy and seatbelt assembly usage for each corresponding one of the seats. An external display is mounted to the vehicle and is directed outwardly and rearwardly of the vehicle. The external display is electrically coupled to the processor and is configured to indicate which of the seats are occupied and which of the seatbelt assemblies includes an engaged buckle.

### BACKGROUND OF THE DISCLOSURE

Field of the Disclosure

The disclosure relates to seatbelt usage indicators and more particularly pertains to a new seatbelt usage indicator for providing information external of a vehicle as to whether or not occupants of the vehicle are wearing their seatbelt.

### SUMMARY OF THE DISCLOSURE

An embodiment of the disclosure meets the needs presented above by generally comprising a vehicle that has a plurality of seats positioned therein. Each seat includes a seatbelt assembly and each seatbelt assembly includes a buckle with an engagement sensor to detect if a buckle of an associated one of each the seatbelt assembly is engaged or disengaged. Each of the seats has one of a plurality of occupant sensors therein. A processor is mounted in the vehicle. Each of the occupant sensors and each of the engagement sensors are electrically coupled to the processor. The engagement sensors are each associated with one of the occupant sensors to define a paired sensor indicating occupancy and seatbelt assembly usage for each corresponding one of the seats. An external display is mounted to the vehicle and is directed outwardly and rearwardly of the vehicle. The external display is electrically coupled to the processor and is configured to indicate which of the seats are occupied and which of the seatbelt assemblies includes an engaged buckle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of an internal display of a vehicle occupant and seatbelt usage indicating system according to an embodiment of the disclosure.

FIG. 2 is a schematic block diagram view of an embodiment of the disclosure.

FIG. 3 is a front view of an embodiment of the disclosure.

FIG. 4 is a rear perspective view of an embodiment of the disclosure.

### DESCRIPTION OF THE PREFERRED EMBODIMENT

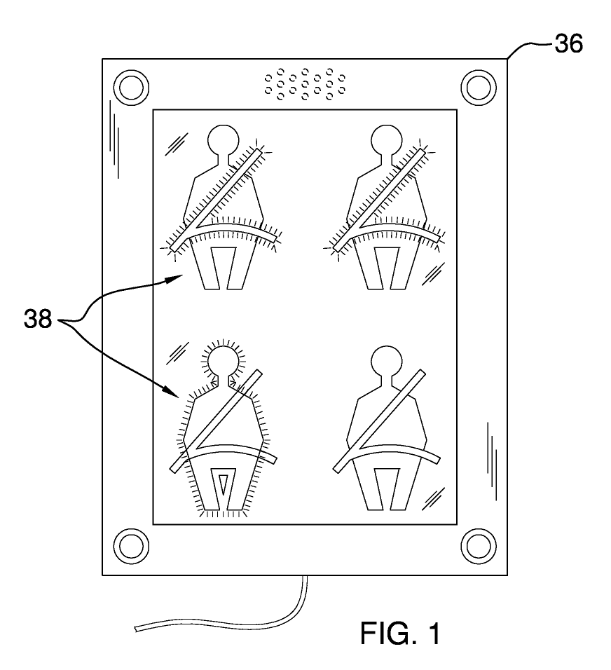

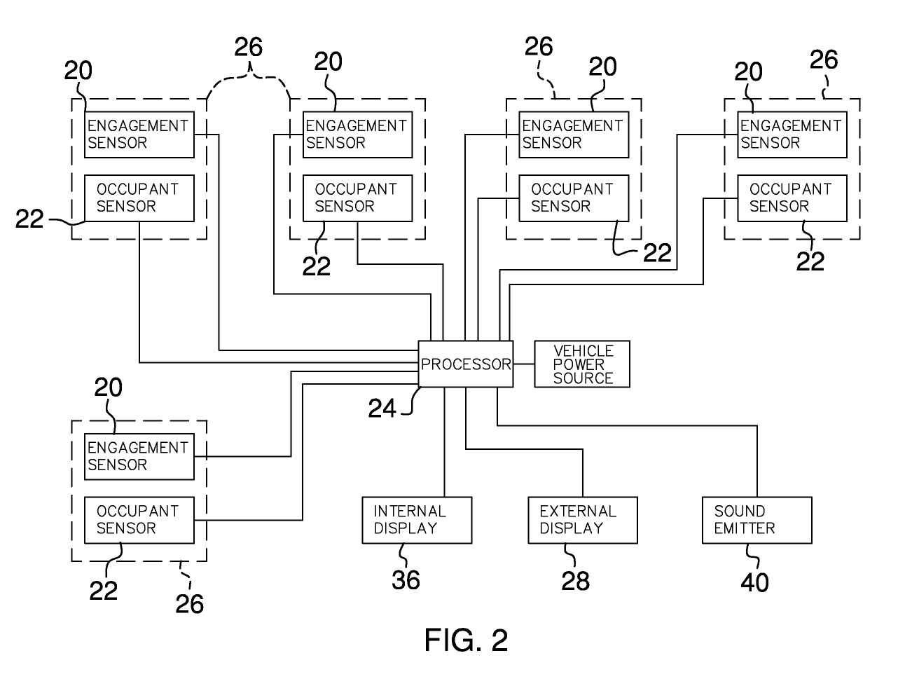

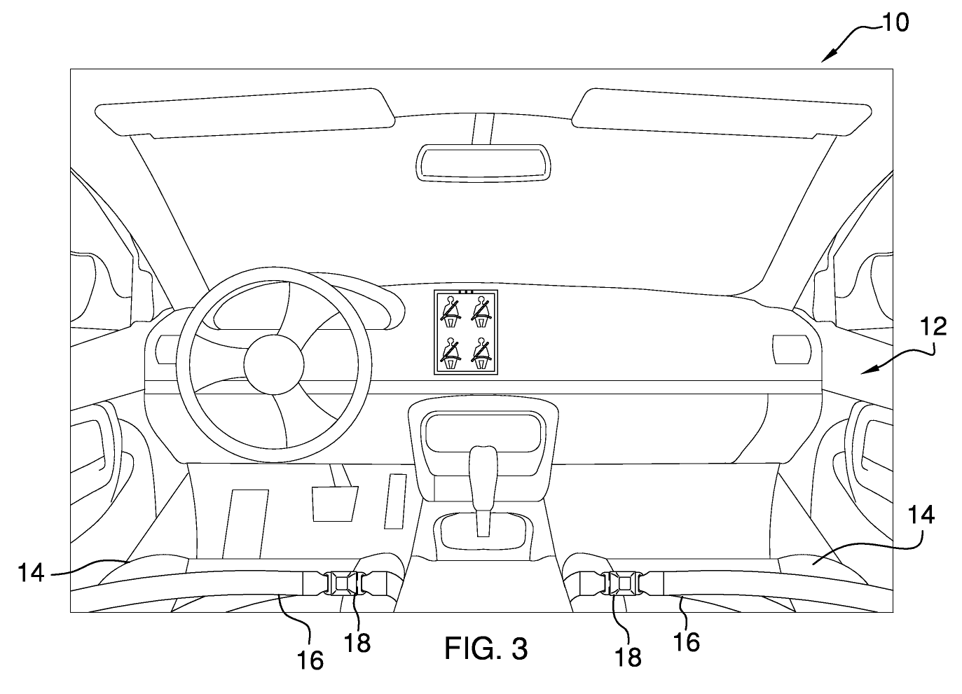

With reference now to the drawings, and in particular to FIGS. 1 through 4 thereof, a new seatbelt usage indicator embodying the principles and concepts of an embodiment of the disclosure and generally designated by the reference numeral 10 will be described.

As best illustrated in FIGS. 1 through 4, the vehicle occupant and seatbelt usage indicating system 10 generally comprises a vehicle 12 having a plurality of seats 14 positioned therein. The vehicle 12 may be any conventional vehicle 12 and more particularly may comprise a typical passenger vehicle including cars, pick-up trucks, sport utility vehicles and the like. The seats 14 may come in a variety of configurations typical to each make of vehicle 12 and therefore may number from two seats 14 and up to eight seats 14. Each seat 14 includes a seatbelt assembly 16 which is conventional and includes a buckle 18 including an engagement sensor 20 to detect if a buckle 18 of an associated one of each the seatbelt assemblies 16 is engaged or disengaged. Such engagement sensors 20 typically include a chip or circuit to detect when the male member of the buckle engages the female member of the buckle 18.

A plurality of occupant sensors 22 is provided and each of the seats 14 has an occupant sensor 22 therein. The occupant sensors 22 are typically weight sensors which detect whether a person is seated upon the associated seat such 12 that the weight sensor can detect the weight of the person. A minimum weight of between 10.0 lbs and 25.0 lbs may be required for the occupant sensor 22 to detect the weight.

A processor 24 is mounted in the vehicle 12. Each of the occupant sensors 22 and each of the engagement sensors 20 is electrically coupled to the processor 24, wherein each of the engagement sensors 20 is associated with one of the occupant sensors 22 to define a paired sensor 26 indicating “no occupant” when the occupant sensor 22 detects no person in an associated one of the seats 14, “occupied without fastening” when the occupant sensor 22 detects a person and the engagement sensor 20 detects an associated buckle is disengaged, or “occupied with fastening” when the occupant sensor 22 detects a person and the engagement sensor 20 detects an associated buckle 18 is engaged.

An external display 28 is mounted to the vehicle 12 and is directed outwardly and rearwardly of the vehicle 12. The external display 28 may comprise one or more screens including LED or LCD screens, for example. The external display 28 is electrically coupled to the processor 24 and is configured to indicate which of the seats 14 are occupied and which of the seatbelt assemblies 16 includes an engaged buckle 18. The external display 28 is electrically displays status indicia for seat 14 occupancy and seatbelt assembly 16 usage corresponding to the paired sensor 26 for each of the seats 14. The status indicia visually indicates no occupant, occupied without fastening or occupied with fastening corresponding to a signal received from the paired sensor 26 associated with each the seat 14. The status indicia may take any conventional form to provide the desired message. For example, the status indicia may show only an outline or a non green or blue color to represent an empty seat. However, an empty seat 14 may be represented by the status indicia for that seat displaying no illumination. For an occupied seat wherein the person is not using the seatbelt assembly, a red illumination of light which may or may not be in the shape of a person may be displayed. For an occupied seat wherein the person is using the seatbelt assembly 16, a green illumination of light may be utilized that may further be in the shape of a seatbelt assembly image. A person, such as a police officer, viewing the vehicle from the rear will immediately be able to determine if all occupants are using their seatbelt assemblies 16 as well as the number of occupants in the vehicle 12.

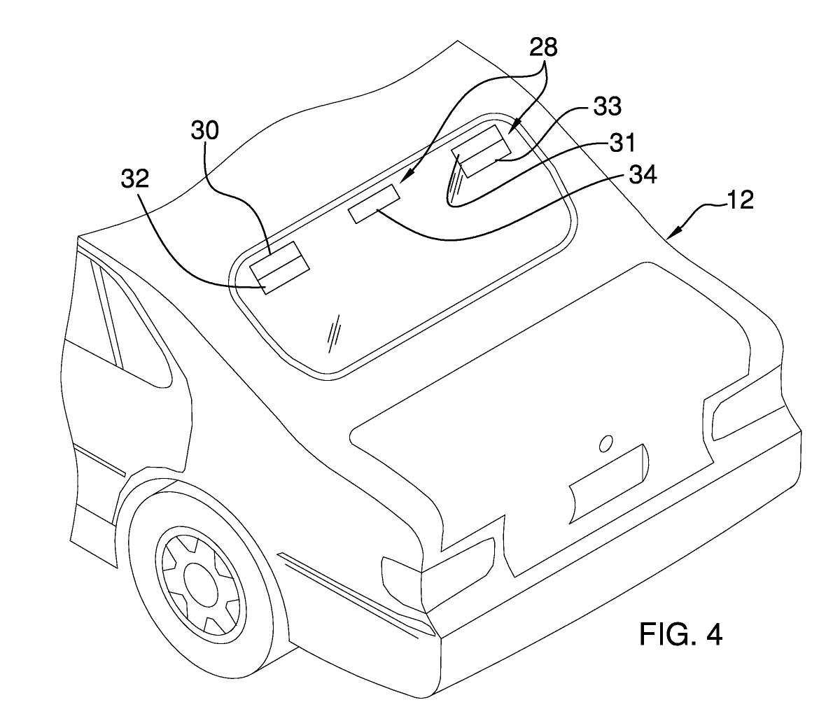

The external display 28 may be such that it provides a discrete indicator for each seat 14 wherein the discrete indicators for the seats 14 are spatially positioned relative to each other to represent spatial position of the seats relative to each other. For example, as shown in FIG. 4, a car having two front seats and a rear bench for three people will include a front right indicator 30, a front left indicator 31, a rear right indicator 32, a rear left indicator 33 and a rear middle indicator 34 each being generally positioned in a pattern similar to the pattern of the seats 14. This will give the viewer of the external display an immediate visualization of where each seat 14 is and where the occupants of the vehicle 12 are located.

An internal screen 36 may be mounted on a dashboard of the vehicle 12 and is electrically coupled to the processor 24. The internal screen 36 visually indicates which of the seats 14 is occupied and which of the seatbelt assemblies 16 includes an engaged buckle 18. The internal screen 36 may generally mirror that of the external display 28 and may include indicators 38 such as an illuminated seatbelt to show the occupant is using their seatbelt assembly 16 and an illuminated seated person with the seatbelt not illuminated to show that the occupant is not using their seatbelt assembly 16. A sound emitter 40 may be electrically coupled to the processor 24 wherein the sound emitter 40 will emit a sound when an occupant is detected who is not using their seatbelt assembly 16.

In use, the system 10 is used in combination with a vehicle's conventional restraint system but which provides additional information with respect to the occupants and their usage of seatbelt assemblies 16. More particularly, the system 10 will inform persons outside of the vehicle 12 as to the status of where occupants are positioned and whether or not they are properly utilizing the vehicle's seatbelt assemblies 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A seatbelt usage indicating system configured to indicate if each occupant of a vehicle is utilizing a seatbelt:
a vehicle having a plurality of seats positioned therein, each seat including a seatbelt assembly, each seatbelt assembly including a buckle including a engagement sensor to detect if a buckle of an associated one of each said seatbelt assembly is engaged or disengaged;
a plurality of occupant sensors, each of said seats having an occupant sensor therein;
a processor being mounted in said vehicle, each of said occupant sensors and each of said engagement sensors being electrically coupled to said processor, each of said engagement sensors being associated with one of said occupant sensors to define a paired sensor indicating occupancy and seatbelt assembly usage for each corresponding one of said seats;
an external display being mounted to said vehicle and being directed outwardly and rearwardly of said vehicle, said external display being electrically coupled to said processor and being configured to indicate which of said seats are occupied and which of said seatbelt assemblies includes an engaged buckle, wherein said external display provides a discrete indicator for each seat wherein said discrete indicators for said seats are spatially positioned relative to each other to represent spatial position of said seats relative to each other such that said external display is configured to provide an immediate visualization of where each seat is and where each occupant of the vehicle is located.

2. The seatbelt usage indicating system according to claim 1, each paired sensor indicating no occupant when said occupant sensor detects no person in an associated one of said seats, occupied without fastening when said occupant sensor detects a person and said engagement sensor detects an associated buckle being disengaged, or occupied with fastening when said occupant sensor detects a person and said engagement sensor detects an associated buckle being engaged.

3. The seatbelt usage indicating system according to claim 2, wherein said external display externally displaying status indicia for seat occupancy and seatbelt assembly usage corresponding to said paired sensor for each of said seats, said status indicia visually indicating no occupant, occupied without fastening or occupied with fastening corresponding to a signal received from said paired sensor associated with each said seat.

4. (canceled)

5. The seatbelt usage indicating system according to claim 1, further including an internal screen being mounted on a dashboard of said vehicle and being electrically coupled to said processor, said internal screen visually indicating which of said seats is occupied and which of said seatbelt assemblies includes an engaged buckle.

6. A seatbelt usage indicating system configured to indicate if each occupant of a vehicle is utilizing a seatbelt:
a vehicle having a plurality of seats positioned therein, each seat including a seatbelt assembly, each seatbelt assembly including a buckle including a engagement sensor to detect if a buckle of an associated one of each said seatbelt assembly is engaged or disengaged;
a plurality of occupant sensors, each of said seats having an occupant sensor therein;
a processor being mounted in said vehicle, each of said occupant sensors and each of said engagement sensors being electrically coupled to said processor, each of said engagement sensors being associated with one of said occupant sensors to define a paired sensor indicating no occupant when said occupant sensor detects no person in an associated one of said seats, occupied without fastening when said occupant sensor detects a person and said engagement sensor detects an associated buckle being disengaged, or occupied with fastening when said occupant sensor detects a person and said engagement sensor detects an associated buckle being engaged;
an external display being mounted to said vehicle and being directed outwardly and rearwardly of said vehicle, said external display being electrically coupled to said processor and being configured to indicate which of said seats are occupied and which of said seatbelt assemblies includes an engaged buckle, said external display being electrically coupled to said processor, said external display externally displaying status indicia for seat occupancy and seatbelt assembly usage corresponding to said paired sensor for each of said seats, said status indicia visually indicating no occupant, occupied without fastening or occupied with fastening corresponding to a signal received from said paired sensor associated with each said seat, said external display providing a discrete indicator for each seat wherein said discrete indicators for said seats are spatially positioned relative to each other to represent spatial position of said seats relative to each other such that said external display is configured to provide an immediate visualization of where each seat is and where each occupant of the vehicle is located; and
an internal screen being mounted on a dashboard of said vehicle and being electrically coupled to said processor, said internal screen visually indicating which of said seats is occupied and which of said seatbelt assemblies includes an engaged buckle.
